(19) United States
(12) Patent Application Publication
(10) Pub. No.: US 2010/0095900 A1
(43) Pub. Date: Apr. 22, 2010

(54) DEVICE AND METHOD FOR CONTROLLING INSECTS

(75) Inventors: Robert Bruce Albright, Chalfont, PA (US); Shobhan Sabnis, Pennington, NJ (US); Jacob Allen Zupan, Yardley, PA (US)

Correspondence Address: WYETH LLC;PATENT LAW GROUP, 5 GIRALDA FARMS, MADISON, NJ, 07940, US

(73) Assignee: Wyeth LLC, Madison, NJ (US)

(21) Appl. No.: 12/623,783

(22) Filed: Nov. 23, 2009

Related U.S. Application Data
(63) Continuation-in-part of application No. 11/435,663, filed on May 17, 2006.
(60) Provisional application No. 60/684,201, filed on May 24, 2005.

(51) Int. Cl. A01K 13/00

(52) U.S. Cl. 119/651; 119/654; 119/655

(57) ABSTRACT

The present invention provides novel insecticidal animal ear tags, neck collars or pendants, and a method for controlling insects in a homeothermic animal.

### CROSS-REFERENCE TO RELATED APPLICATIONS

This application is a continuation-in-part of U.S. application Ser. No. 11/435,663, filed May 17, 2006, which claims the benefit under 35 U.S.C. §119(e) to U.S. Provisional Application No. 60/684,201, filed May 24, 2005, both of which are hereby incorporated by reference in their entirety.

### BACKGROUND OF THE INVENTION

The present invention relates to a device and method for controlling insects. Many recently developed techniques used for the control of insects involve slow-release pesticide technology. The use of pest strips, collars, bands, and tags which have an insecticide contained throughout the substrate of the final device are described in U.S. Pat. No. 3,318,679; U.S. Pat. No. 3,944,662; U.S. Pat. No. 3,756,200; U.S. Pat. No. 3,942,480 and U.S. Pat. No. 4,195,075. The latter patent describes an insect control device containing an insecticidally active isomer of alpha-cyano-3-phenoxy-benzyl-alpha-isopropyl-4-chlorophenylacetate. U.S. Pat. No. 5,104,569 describes coated devices that enable the incorporation of insecticidal agents that were not suitable for incorporation into devices prepared by extrusion and injection molding.

The increased popularity of devices such as insecticidal animal ear tags, neck-worn collars and pendants over the past few years has resulted in considerable effort to develop improved devices to overcome the problems that become apparent as their use increases. Improvements in design, compositions, and manufacturing techniques are constantly being sought to overcome problems such as breakage and loss, and to improve efficacy and ease of application. Breakage and loss occur in ear tags such as those described in U.S. Pat. No. 3,731,414, due to their size, design and method of attachment which results in portions of the tag being subjected to flex and stress in the field for prolonged periods of time. Additionally, breakage or weakness of a plastic tag can result from the incorporation of an active ingredient or mixture of active ingredients that may actually weaken the polymer matrix. Further, the particular characteristics of the active ingredient require attention to ensure that the active ingredient maintains its insecticidal activity in the polymer matrix.

Interference or degradation of an active component with or during the polymerization or manufacturing process, resulting in weakness and breakage of the resultant ear tag, is an area of great concern in the preparation of animal ear tags. An increase in the concentrations of active component is a limiting factor to the strength of the resulting plastic tag.

It is an object of this invention to provide compositions and devices that are not restricted by the above limitations.

### SUMMARY OF THE INVENTION

The present invention provides a composition that comprises an effective amount of metaflumizone in the form of an ear tag, neck collar or pendant for use with homothermic animals.

The ear tag may be in either a one-component form, or the form of a two-component ear tag, that will withstand the flex and stress pressures present in the field over prolonged periods of time, thereby resulting in reduced ear tag breakage and loss. The ear tags, neck collars or pendants, advantageously, are capable of holding a high concentration of metaflumizone, thereby increasing their efficacy and spectrum of activity; especially for insects which plague cattle, dogs, cats and other homothermic animals that graze or otherwise spend time in open areas. An additional advantage of a two-part animal ear tag of this invention is that the second component may be replaced without having to repuncture the ear of the animal each time the insecticide needs replacing.

In one embodiment, the present invention is an animal ear tag, neck collar or pendant comprising about: 40% to 99% or 40% to 90% of a thermoplastic resin; and 1% to 30% of metaflumizone. Optionally, 0.0% to 4.0% of a processing stabilizer; 0.2% to 10.0% of a lubricant; 0.3% to 0.5% of a chelating agent; 1% to 2.5% of a heat processing stabilizer; 0% to 5.0% of a flow agent; 0% to 35.0% of insecticidal synergists and migration accelerators; 5.0% to 25.0% of a plasticizer or mixture of plasticizers; 0.5 to 2.0% colorant; and 0 to 30% of one or more additional insecticidal agents may also be added. Alternatively, the composition comprises 0.0% to 5.0% of a stabilizer; 0% to 10.0% of a lubricant; 0% to 0.5% of a chelating agent; 0% to 5.0% of a flow agent; 0% to 35.0% of insecticidal synergists and migration accelerators; 5.0% to 50.0% of a plasticizer or mixture of plasticizers; 0.5 to 2.0% colorant; and 0 to 30% of one or more additional insecticidal agents may also be added. In a further embodiment, the composition is impregnated or coated onto a mesh matrix component of a natural or synthetic cloth or fiber or wire or a solid dispersion of polyvinylchloride polymer or copolymer to form an ear tag, neck collar or hanging pendant device.

In an additional embodiment of the present invention, the thermoplastic resin comprises a phthalate. More particularly, the phthalate is dialkylphthalate. More particular still, the phthalate is diethylphthalate. In another embodiment, the thermoplastic resin comprises polyvinyl chloride. In another embodiment, the thermoplastic resin comprises polyvinyl chloride and diethylphthalate. More particularly, the thermoplastic resin comprises about 25% to about 50%, 30% to 40% or about 35% of polyvinyl chloride and about 40% to about 60%, 45% to 55%, or about 50% of diethylphthalate. In another embodiment, the composition comprises about 5% to about 20%, 5% to 15% or about 10% of metaflumizone. In another embodiment, the ear tag is fabricated on a matrix of a natural or synthetic cloth or fiber mesh, wire mesh or a solid dispersion of polyvinylchloride polymer or copolymer. In another embodiment, the composition comprises at least one stabilizer. In a more particular embodiment the stabilizer is at least one of expoxidized soy bean oil, calcium and zinc. In another embodiment, the composition comprises about 0.5% to about 2.0% of a colorant. More particularly, the colorant is TiO₂ and optionally comprises about 1% TiO₂. In another embodiment, the composition comprises on a weight basis about: about 5% to about 15% metaflumizone; about 25% to about 50% of polyvinyl chloride (PVC); and about 40% to about 60% of diethylphthalate. More particularly, the composition comprises about 10% metaflumizone, about 35% PVC and about 50% diethyl phthalate.

### DETAILED DESCRIPTION OF THE INVENTION

The design and manufacture of insecticidal collars, pendants and ear tags present significant challenges for formulators. The devices must be able to incorporate a sufficient amount of an effective insecticide to produce the desired effect, while being able to release and deliver the insecticide at such a rate so as to provide effective insect control. In addition, the devices must be strong enough to survive a harsh environment. This includes the physical rigors of being twisted and pulled by the animals that wear them, such as cattle, as well withstanding rain, sunlight and other weather effects.

In order to preserve durability, longevity and efficacy in ear tags, collars and pendants, ingredients that are easy to formulate and have minimal stability issues are generally selected. Active ingredients, such as permethrin and organophosphates, which are highly lipophilic, low melting solids or liquids with good solubility in most organic solvents, are typically selected. These molecules have a high thermodynamic activity which enhances their deliverability. Conversely, if a molecule has a low thermodynamic activity, it means that the crystal structure is highly organized and a great deal more energy is required to convert to the liquid state. This makes the molecule difficult to manipulate from a delivery standpoint.

Metaflumizone is a new insecticidal entity that shows promise as an active ingredient against of number of undesirable insect species. However it is a high melting solid and is relatively insoluble in many organic solvents. The melting point is 176° C. for metaflumizone, which is indicative of a highly ordered crystal state.

Additionally, metaflumizone has poor solubility and instability in a number of solvents typically used in formulations. Because of these properties, metaflumizone would generally not be considered an agent ideally suited for animal ear tags, collars and pendants. Surprisingly it has been discovered that in the particular formulations described herein, the non-ideal physical properties of metaflumizone are overcome and are actually provide for a very effective insecticide in solid state delivery devices such as ear tags, collars and pendants.

Metaflumizone has a very high solubility in diethyl phthalate allowing for formulation of a PVC matrix where much of the active ingredient is dissolved in a solvent. Diethyl phthalate also allows metaflumizone to exist in a less ordered and molecularly active state, which enhances the movement of the active ingredient out of the PVC matrix and onto the animal. The undissolved metaflumizone can then act as a reservoir to keep the solvent in a saturated state. The use of diethyl phthalate and PVC with metaflumizone has resulted in an ear tag that is surprisingly durable while providing 70-90 days of control of cattle horn flies and.

Additionally, in a two-part ear tag device or a pendant, the first component is constructed so as to be attached to the animal and may be constructed of virtually any material of suitable size and strength. Preferably the first component is manufactured from thermoplastic resin materials, such as polyvinylchloride resins and polyurethrane elastomers or impregnated cloth, fabric, or other material.

A suitable pin, clip or ring for the two part ear tag or pendant embodiment of the invention may be of any design including that of a bayonet type system, provided it holds the ear tag or pendant in place. A means for securing the pin may optionally be employed and it may be either an integral part of the design or an independent unit. U.S. Pat. No. 3,731,414, which is herein incorporated by reference, discloses a preferred means of attachment to the animal's ear which is suitable for the present invention.

The component carrying the metaflumizone is normally comprised on a weight basis of about 40% to 99% or 40% to 90% of a thermoplastic resin comprising polyvinylchloride and optionally other ingredients, particularly a plasticizer such as a phthalate, preferably diethylphthalate. Metaflumizone is preferably present at about 1% to 30% or more particularly 5% to 15%. Depending upon the characteristics of the polyvinylchloride or other thermoplastic resin chosen, other optional components may include about 0.0% to 4.0% of a processing stabilizer such as epoxidized soybean oil; about 0.0% to 10.0% or 0.02% to 10.0% of a lubricant such as stearic acid; 0.0% or 0.3% to 0.5% of a chelating agent such as trinonylphosphite; about 0.1% to 2.5% of a heat processing stabilizer such as calcium-zinc stearate or stabilizer blend; about 0% to 5.0% of a flow agent such as SiO₂; about 0% to 35.0% of insecticidal synergists and migration accelerators such as piperonyl butoxide; about 0% to 70.0% of a plasticizer or mixture of plasticizers such as an phthalate, including dialkylphthalate, dioctylphthalate, benzylbutylphthalate, dibutylphthalate, diethylphthalate, citrate esters, adipates or sebacates; and about 1% to 30% of additional insecticidal agents, such as amitraz, fipronil, imidachloprid, permethrin, pyrethrins, piperonyl butoxide, chlorfenapyr or fenothrin. If desired, a colorant, in the amount of about 0.5 to 2.0% can be added, such as, to provide distinction of animals with the metaflumizone-bearing device. A preferred colorant is TiO₂. Additional agents to be added include epoxidized soybean oil, preferably at about 1% to 5%, more particularly about 3%.

Metaflumizone is a new insecticide, described in U.S. Pat. No. 5,543,573, and U. S. Published Application 2004-0122075A1, both incorporated herein by reference.

The metaflumizone-bearing component may be fabricated out of a material which is different from the material of the first component. This metaflumizone-bearing component may be fabricated on a matrix such as a natural or synthetic cloth or fiber mesh for example, polyaramid or a polyester, wire mesh or a solid dispersion of polyvinylchloride polymer or copolymer matrix by coating, extruding, coextruding or impregnating the metaflumizone-resin composition onto the matrix. Alternatively, the metaflumizone component can be introduced at the formation stage of the thermoplastic resin and incorporated into the tag as a single unit device.

The metaflumizone-bearing component may be fabricated by preparing a blend of the dry ingredients by admixing them in a blender, heating the mixture while blending it in a temperature range of 80° C. to 120° C. and slowly adding a mixture of the liquid ingredients and mixing until a relatively dry blend is obtained. The resulting homogeneous blend is cooled while mixing and the optional SiO₂ added and blended in to obtain a homogeneous dry blend, which may then be molded, extruded or coextruded optionally onto a matrix or the dry blend may then be pelletized by extrusion and the pelletized dry blend then molded, extruded, or coextruded optionally onto a matrix as described above and punched or cut into the desired shape. Alternatively, the metaflumizone-bearing component may be prepared by coating or dipping a matrix with a vinyl dispersion containing the active ingredients, as disclosed herein by U.S. Pat. No. 5,104,569 which is incorporated by reference. Additionally, this metaflumizone-bearing component may contain more than one section. Individual sections may be composed of the same or different ingredients and may also provide different release rates of active ingredients. Such a second component allows for the application of active ingredients which would not be compatible in a single section as well as an alternative method for delivering mixtures of active ingredients at the same or different rates.

For some applications, it has been found that the use of impregnated coated, extruded or co-extruded fabric matrix tags of a one piece design offers several advantages over conventional one piece molded tags. When a composition containing an insecticidally active ingredient or mixture of insecticidally active ingredients is fabricated on a matrix of natural or synthetic cloth or fiber mesh, or a wire mesh, the result is a stronger ear tag which is less prone to breakage and thus allows a greater range of compositions to be incorporated into the tag. Also, the one piece matrix animal ear tag, due to the strength of the matrix, is not as restricted in the means of attachment to the ear as a plastic molded ear tag. Such matrix materials are also suitably formed as neck collars or pendants.

The invention is further illustrated by the following non-limiting examples. The first or second components shown herein are intended to encompass all design modifications including different shapes and sizes.

### Example 1

### Preparation of a Single Component Ear Tag or Neck Collar

### A. Dry Blend

Dry blends of various compositions are prepared utilizing the ingredients listed in Table I below by blending the solid ingredients until a homogeneous mixture is obtained and then heating the mixture to 85° C. A mixture of the liquid ingredients is then slowly added to the agitated mixture. When all of the liquid is added to the mixture, the mixture is heated to 110° C. and agitated for 10 minutes. The agitated blend is cooled to 70° C. and sufficient SiO₂ is added to obtain a free-flowing dry blend. The dry blend is then cooled to ambient temperatures and collected.

TABLE I

| | Wt (g) | % Wt of Dispersion |
|---|---|---|
| Polyvinylchloride resin | 100 | 44.4-62.9 |
| Epoxidized Soybean Oil | 10.88 | 4.8-6.8 |
| Stearic Acid | 0.54 | 0.2-0.3 |
| Trinonylphosphate | 0.65 | 0.3-0.4 |
| Ca/Zn Stearate | 1.96 | 0.9-1.2 |
| SiO₂ | 0.71 | 0.3-0.4 |
| Hyp 212P | 0.44 | 0.2-0.3 |
| Hyp 211P | 0.76 | 0.3-0.4 |
| HW 132P | 1.09 | 0.5-0.7 |
| UV Stabilizer 5411 | 0.65 | 0.3-0.4 |
| Metaflumizone | 17.74 to 40.00 | 7.9-25.2 |
| Plasticizers mixture | 18.9 to 46.0 | 8.4-29.5 |
| benzylbutylphthalate | | |
| dibutylphthalate | | |
| dioctylphthalate | | |
| acetyltributyl citrate | | |
| dioctyladipate | | |

### B. Pelletizing

The compositions prepared in A above may be pelletized using standard low shear extruders at elevated temperatures normally in the range of 300° F. to 350° F. The resulting extruded material is then cut to the desired size by air chopping and the resulting pellets are packaged.

### C. Injection Molding

Pellets prepared as in B above are charged to a 350 ton press and the temperature and time profile is set to 325° F. for twenty seconds. The compositions are molded to the desired size by injection molding or extruded and the resulting components packaged.

Another method of preparation of single phase ear tags would be to dry blend the following ingredients at room temperature:

| Ingredient | Amount (parts) |
|---|---|
| Modified PVC such as Superkleen ® | 69-89 |
| polyvinyl chloride resin (sold by AlphaGary) | |
| Metaflumizone | 10 to 30 |
| Colorant (as needed) | 0-1 |

These ingredients, after dry blending in an appropriate mixer such as a ribbon blender, are then transferred to a single or twin screw extruder which in turn feeds an injection molding device to mold to the desired form or configuration

### Example 2

### Preparation of Cloth Matrix Metaflumizone Components

Metaflumizone-bearing components are prepared using the dry blends prepared as described in Example 1A, containing 54 parts by weight of the metaflumizone, and 18 parts by weight of several plasticizers per 100 parts of PVC. These dry blends are pelletized and extruded onto a cloth matrix and punch and die cut to the desired shape giving an insecticidal component weighing approximately 8 grams.

### Example 3

### Preparation of Metaflumizone Coating Composition

Acetyl tributyl citrate 180 g is added to a stirred mixture of 300 g of a vinyl resin having an inherent viscosity of 1.20 and average particle size of 0.95 microns and optionally 6 g of Ca/Zn stearate and 9 g of epoxidized soybean oil. To this stirred mixture is added 100 g of metaflumizone (90% pure). The resulting mixture is stirred until homogeneous and then deaerated at room temperature overnight at 686 mm/Hg.

### Example 4

### Preparation of Metaflumizone-Containing Component of A Two-Piece Tag Containing Metaflumizone

A solid matrix is preheated to 100° C. and dipped into the insecticidal coating composition prepared in Example 2. The resulting coated components are cured in an oven at 90° C. to 135° C. for five to eight minutes, resulting in coated matrixes containing 1.7 g to 2.86 g of the metaflumizone coating composition.

### Example 5

### Preparation of Coated Matrix Containing Metaflumizone

(a) A vinyl dispersion is prepared utilizing the procedure of Example 3 and the materials listed in Table II below.

TABLE II

| Ingredient | Wt (g) | % Wt of Dispersion |
|---|---|---|
| Resin (Inherent viscosity 1.20 average) | 300 | 49.72 |
| (particle Size 0.95 microns) | | |
| Butyl benzyl phthalate | 180 | 29.82 |
| Epoxidized soybean oil | 9 | 1.49 |
| Ca/Zn Stearate | 6 | 0.99 |
| Benzophenone ultraviolet stabilizer | 2 | 0.33 |

(b) Metaflumizone coating compositions may then be prepared by addition of the metaflumizone to the vinyl dispersion prepared in Example 5(a) and blending until homogeneous. The resulting mixture is then deaerated at reduced pressure 686 mm/Hg for 16 hours, giving a metaflumizone composition suitable for preparing coated ear tag devices.

(c) Ear tag insect control devices may then be prepared by coating and curing the resulting coated matrix at 90° C. to 135° C. for 2-10 minutes.

### Example 6

### Co-Extruded Bilayer Cattle Ear Tags Containing Metaflumizone and Various Other Insecticides

Another method of preparation of bilayer ear tags would be prepare two dry blended compositions, one containing metaflumizone, and separately, a dry blend containing another insecticide, such as, but not limited to, amitraz, fipronil, imidachloprid, permethrin, pyrethrins, piperonyl butoxide, chlorfenapyr, fenothrin.

Each of the layers would be prepared in an analogous manner:

### Layer 1

| | | |
|---|---|---|
| Modified PVC Superkleen ® | 100 | parts |
| polyvinyl chloride resin (sold by Alpha Gary) | | |
| Metaflumizone | 10 to 40 | parts |
| Colorant (as needed) | 0-1 | part |

### Layer 2

| | | |
|---|---|---|
| Modified PVC Superkleen ® | 100 | parts |
| polyvinyl chloride resin (sold by Alpha Gary) | | |
| Acetyl tributyl citrate or another acceptable plasticizer | 30 | parts |
| Amitraz | 10 to 30 | parts |
| Colorant (as needed) | 1 | part |

Each of the layers is blended separately in a device such as a ribbon blender. Each composition is loaded into a dual-feed extruder where a single or twin screw extruder in turn feeds an injection molding device. The screw extruder works each phase separately. The resulting molten matrices can then be injected into the mold which is configured as an ear tag with appropriate dimensions for thickness and total ear tag weight, formed under vacuum and then expelled for cooling and curing at room temperature.

### Example 7

### Preparation of a One Piece Matrix Animal Ear Tag by Extrusion Onto Polyester Cloth

Two dry blends are prepared by the procedure of Example 1 containing, on a weight basis, 100 parts PVC, 18.88 parts epoxidized soybean oil, 0.54 parts stearic acid, 0.65 parts trinonylphosphate, 1.96 parts Ca/Zn stearate, 0.44 parts HYP212, 0.76 parts HYP211, 2.0 parts HW132, 0.65 parts UIV stabilizer, 30 parts metaflumizone ; one with 18 parts Benzylbutylphthalate (BBP), and the other with 18 parts acetyltributyl citrate (ATBC). Each of these dry blends is coated onto a fabric mesh matrix by coextruding the melt through a profile die onto the matrix. The resulting impregnated matrix is cut into the shape of a standard one piece animal ear tag weighing approximately 8.5 grams.

These insecticidal ear tags are hung in a chamber covered with mesh cloth to keep the flies confined in the 12×17″×9″ space. Each chamber contains a cup of water and a supply of sugar and powdered milk.

At the start of the test, about 100 three to five day old house flies are placed in each chamber. The chambers are kept in a room with the temperature at 82° F. The flies are observed daily (except Saturday and Sunday) and mortality is recorded. At the termination of the study, the chambers are placed in a freezer overnight to kill the remaining flies, which are counted. The percent mortality is calculated based on the number of flies that die during the observation and the number of flies counted at the end of the study.

### Example 8

A slurry of metaflumizone and diethyl phthalate was stirred and heated to ˜80° C. Virgin PVC, epoxidized soybean oil, calcium-zinc stabilizer and titanium dioxide were heated to ˜80° C. and slowly mixed with the slurry for about 3 hours. The resulting PVC mix was then molded by means of an injection molder to form ear tags having the following formula:

| Ingredient | PerCent |
|---|---|
| Metaflumizone | 10.1 |
| Diethyl Phthalate | 50.0 |
| Virgin PVC | 35.6 |
| Epoxidized Soybean Oil | 3.0 |
| Calcium-Zinc Stabilizer Blend | 0.3 |
| TiO₂ | 1.0 |

Cattle ear tags made in this manner were tested for control of horn flies over a 98 day period of time. The results of a cattle study are shown below in Table II.

TABLE II

| Tr. Group | Pre- | | | | | | | | |
|---|---|---|---|---|---|---|---|---|---|
| (n = 8) | Treatment | 7 | 21 | 35 | 49 | 63 | 77 | 92 | 98 |
| Untreated | 393.8 | 352.5 | 1081.3 | 1250.0 | 1068.8 | 1043.8 | 1210.0 | 1187.5 | 1056.3 |
| Avg. | | | | | | | | | |
| Treated | 400.0 | 4.9 | 3.0 | 7.3 | 14.5 | 83.3 | 105.0 | 127.5 | 391.3 |
| Avg. | | | | | | | | | |
| % | | 98.6 | 99.8 | 99.4 | 98.7 | 92.1 | 91.4 | 89.4 | 63.0 |
| Efficacy | | | | | | | | | |

As evidenced by the results in Table II, the ear tags are very effective for the control of horn flies on cattle.

What is claimed is:

1. An animal ear tag, neck collar or pendant comprising on a weight basis about: 40% to about 90% of a thermoplastic resin; and about 1% to about 30% of metaflumizone.

2. The animal ear tag, neck collar or pendant according to claim 1, wherein the thermoplastic resin comprises a phthalate.

3. The animal ear tag, neck collar or pendant according to claim 2, wherein the phthalate is dialkylphthalate.

4. The animal ear tag, neck collar or pendant according to claim 2, wherein the phthalate is diethylphthalate.

5. The animal ear tag, neck collar or pendant according to claim 1, wherein the thermoplastic resin comprises polyvinyl chloride.

6. The animal ear tag, neck collar or pendant according to claim 1, wherein the thermoplastic resin comprises polyvinyl chloride and diethylphthalate.

7. The animal ear tag, neck collar or pendant according to claim 6, wherein the thermoplastic resin comprises about 25% to about 50% of polyvinyl chloride and about 40% to about 60% of diethylphthalate.

8. The animal ear tag, neck collar or pendant according to claim 1, comprising about 5% to about 15% of metaflumizone.

9. The animal ear tag, neck collar or pendant according to claim 1, wherein the ear tag is fabricated on a matrix of a natural or synthetic cloth or fiber mesh, wire mesh or a solid dispersion of polyvinylchloride polymer or copolymer.

10. The animal ear tag, neck collar or pendant according to claim 1, wherein the composition comprises at least one stabilizer.

11. The animal ear tag, neck collar or pendant according to claim 10, wherein the stabilizer comprises epoxidized soy bean oil.

12. The animal ear tag, neck collar or pendant according to claim 10, wherein the stabilizer comprises calcium and zinc.

13. The animal ear tag, neck collar or pendant according to claim 1, comprising about 0.5% to about 2.0% of a colorant.

14. The animal ear tag, neck collar or pendant according to claim 13, wherein the colorant is TiO₂.

15. The animal ear tag, neck collar or pendant according to claim 1, comprising on a weight basis about:
about 5% to about 15% metaflumizone;
about 25% to about 50% of polyvinyl chloride; and
about 40% to about 60% of diethylphthalate.

16. The animal ear tag, neck collar or pendant according to claim 1 additionally comprising on a weight basis about:
0% to 5% of a stabilizer:
0% to 5.0% of a flow agent;
0% to 35.0% of insecticidal synergists and migration accelerators;
5.0% to 50.0% of a plasticizer or mixture of plasticizers;
0.5 to 2.0% colorant; and
0 to 30% of one or more additional insecticidal agents.

17. The animal ear tag, neck collar or pendant according to claim 1, wherein the composition is impregnated or coated onto a mesh matrix component of a natural or synthetic cloth or fiber or wire or a solid dispersion of polyvinylchloride polymer or copolymer.

18. The animal ear tag, neck collar or pendant according to claim 1, wherein the component is fabricated by extrusion or coextrusion.

19. The animal ear tag, neck collar or pendant according to claim 1, wherein the thermoplastic resin is a polyvinyl chloride resin.

20. The animal ear tag, neck collar or pendant according to claim 1, which includes an additional insecticidal agent.

21. The animal ear tag, neck collar or pendant according to claim 20, wherein the additional insecticidal agent is amitraz.

22. A method for controlling insects in a localized environment, said method comprising: contacting an animal with an ear tag, neck collar or pendant comprising the composition of claim 1.

23. The method of claim 22, wherein the insects are horn flies.
